(19) United States
(12) Patent Application Publication
(10) Pub. No.: US 2013/0179329 A1
(43) Pub. Date: Jul. 11, 2013

(54) CREDIT FINANCING USING STRATIFICATION

(71) Applicant: Mir Jafer Joffrey, Winnetka, IL (US)

(72) Inventor: Mir Jafer Joffrey, Winnetka, IL (US)

(21) Appl. No.: 13/734,803

(22) Filed: Jan. 4, 2013

Related U.S. Application Data
(60) Provisional application No. 61/583,859, filed on Jan. 6, 2012.

(51) Int. Cl. G06Q 40/02

(52) U.S. Cl. CPC G06Q 40/025
USPC 705/38

(57) ABSTRACT

A computerized method of assisting a borrower obtain financing is disclosed. Potential financiers interested in making the type of financing being sought supply financier information, including a minimum credit benchmark. That information is stored in a database. A potential borrower enters financing information regarding a loan or credit card being sought. The potential borrower's credit benchmark is obtained. A computer uses the credit benchmark to form a stratification filter which is overlaid on the database to identify one or more “best” potential financiers for the desired financing. The “best” potential financier is queried to determine if they are interested in granting a loan to someone similarly situated as the potential borrower. If so, information is sent to that potential lender. Otherwise another “best” potential financier is queried.

### RELATIONSHIP TO OTHER APPLICATIONS

The present application claims priority to and the benefit of U.S. provisional application No. 61/583,859 filed 6 Jan. 2012, and is also related to U.S. provisional application No. 61/583,985 filed 6 Jan. 2012, both of which are hereby incorporated by references in full, for all purposes.

### FIELD OF THE INVENTION

The present invention relates to a computer assisted method of providing financing. More specifically, the present invention relates to a computerized method used to stratify consumer loans in a way that reduces negative credit rating impacts on the borrower and improved targeting of applications to potential lenders.

### BACKGROUND OF THE INVENTION

Modern finance has undergone a series of shocks that have stressed capital markets almost to the breaking point. Asset bubbles, defaults, bankruptcies, over leveraged financial institutions, and bailouts continue to dramatically impact the financial and nonfinancial world.

Financing represents a wide family of complex business activities for originating, evaluating, granting, marketing, guaranteeing, and managing loans. As the ready availability of financing remains essential for America's economic well being, the smooth operation of the complex business activities that comprise modern financing is of utmost import.

The complex business activities of finance are performed by an interdependent set of financial networks that are each comprised of numerous players. There are individual and corporate borrowers who wish to obtain low cost financing. There are lenders such as commercial banks, savings and loan associations, and credit unions that wish to make profitable loans. There are entities that obtain and move capital from one bank to another, often across national borders. There are government regulators and entities, such the U.S. Federal Reserve Banks who regulate the financial industry and implement a nation's monetary policy. There are national credit rating agencies that track and compile credit histories on almost every entity in the United States and, at the request of a possible lender, will sell credit reports that are useful for determining the credit worthiness of potential borrowers. When a credit rating agency provides a credit report on an entity, that act is referred to herein as a credit pull. Then there are a whole host of auxiliary financial players such as insurers, marketers, secondary market lenders, loan packagers, collectors, asset evaluators, lawyers, and judges that make financial markets run smoother.

Core financing activities specifically include risk assessment, which relates to determining how likely a potential loan will be repaid, and risk containment, which relates to determining what will happen if a borrower defaults on paying back the loan. Generally speaking there are two basic types of loans: secured loans and unsecured loans. While various activities such as loan insuring and asset depletion cause overlap between those two basic types, those loans types form the basis for almost all consumer credit.

In practice the two basic types of loans are handled very differently by most financial entities. For example, national credit rating agencies will usually not lower the credit rating of a potential borrower because of multiple credit pulls to obtain secured loans. Essentially a potential borrower can apply for as many secured loans as they want from numerous lenders without harming their credit rating. However, those same credit rating agencies can and do lower credit ratings because of multiple credit runs for unsecured loans. Thus, if a qualified potential borrower applies to many lenders for an unsecured loan or a credit card, and if those lenders all request credit reports on that potential borrower the potential borrower's credit may be so harmed that they no longer qualify for the credit card or loan they are applying for. A downgraded credit rating may take years to recover.

Various computer based auction models have been developed for assisting a borrower obtain secured financing. Those models often use the ready availability, power, and speed of the internet. For example, LendingTree.com™ has developed a method of financing secured loans in which a potential borrower's information is shared with numerous lending institutions so that those institutions can “compete” to grant a loan to that potential borrower, thus enabling competition that may help that borrower to obtain better terms. Using that model each lending institutions can still (and usually do) make a credit pull on the borrower, but the borrower's credit is not harmed as the loan would be for a secured loan. Typically a successful lender pays a fee for finding a borrower.

For unsecured loans there are far fewer (if any) uses of computers and the internet to assist obtaining financing in a way that benefit a potential borrower. In particular, the problem created by multiple credit pulls does not appear to have specifically addressed in the prior art. Yet, credit downgrades based on multiple credit pulls is a big problem for potential borrowers. Should a consumer request multiple credit cards each credit card provider would request a credit pull and thus damage the consumer's credit rating. If the consumer wishes to apply to multiple lenders for a loan each lender might request a credit pull and thus damage the consumer's credit rating.

The problem of multiple credit pulls when a consumer seeks to obtain financing for an elective medical procedure does not appear to have been addressed in the prior art. Elective medical procedures are procedures that are not covered by either governmental insurance (for example, Medicare) or private insurance. Elective medical procedures tend to be relatively expensive. If a patient wants a tummy tuck they need to come up with the money. To do so many patients must obtain loans to finance their procedure. Unfortunately, loans to finance elective medical procedures are unsecured.

Prior to the recent economic downturn experienced by the United States obtaining an unsecured loan for elective medical procedures was not particularly difficult since several large financing companies made unsecured medical procedures loans readily available. Those companies targeted unsecured medical procedures loans and they made their services known to medical professionals. Thus medical professionals were aware of where to direct their patients to obtain required financing. Those large financing companies tended to have relatively similar loan qualification requirements and applying to one or two of them for a loan would likely not seriously harm the credit rating of a potential borrower. Additionally, medical professionals understood the loan requirements and could advise potential borrowers accordingly.

But, because of the recent economic downturn obtaining an unsecured loan for an elective medical procedure has become far more difficult. Some large companies have left the market, others have tightened their loan requirements, and new companies with differing and little understood loan requirements have entered the market. Nowadays many patients risk numerous rejections of their loan applications before finding a suitable lender to finance a medical procedure. Furthermore, patients who obtain elective procedure financing may be paying too much for that financing because they did not apply to a lender who would have given them a better deal.

Therefore, a method of assisting unsecured loan financing in a way that benefits potential borrowers would be beneficial. Even more beneficial would be a computerized method of assisting unsecured loan financing, such as obtaining credit cards, in a way that benefits potential borrowers by reducing the number of credit pulls and subsequent harm to their credit. Even more useful would be a computer based method of assisting patients obtain unsecured financing of elective medical procedures in a way that improves the chances of obtaining a loan. Preferably, that method would benefit a patient by reducing the number of credit pulls while assisting them obtain better loan terms.

### BRIEF SUMMARY OF THE INVENTION

The principles of the present invention enable computerized methods of assisting a borrower to obtain a credit card or a loan but requires fewer credit inquiries (“credit pulls”) than conventional methods, thus reducing harm to their credit rating. The currently disclosed methods and systems further enable a computerized method of assisting a patient to obtain financing for an elective medical procedure in a way that reduces credit pulls, lessens harm to credit rating, and improves the chances of obtain the required financing.

A computerized credit stratification system in accord with the principles of the present invention assists loan seekers to obtain desired loans or credit cards. That system includes a computer that operates using application software that causes the computer to implement a database and a communication dataport. The database includes at least one loan term and a credit benchmark, such as a credit score, that is required for a loan from each of a plurality of potential lenders. The computer obtains application information from a loan-seeker and obtains a credit benchmark (score) for that loan-seeker from a credit rating agency. The database is searched to identify potential lenders that will consider granting a loan to a potential borrower having the loan-seeker's credit benchmark (score). Potential lenders that might grant a loan to a potential borrower having the loan-seeker's credit benchmark (score) are then stratified to identify a “best” potential lender for the borrower. That best potential lender is then queried as to whether they are interested in making the desired loan to a potential borrower having said loan-seeker's credit benchmark (score). If the best potential lender declines to make the desired loan the computer selects another “best” potential lender and then that potential lender is queried as to whether they are interested in making the desired loan to a potential borrower having the loan-seeker's credit benchmark (score).

In one important commercial embodiment, the computerized credit stratification system can be used to obtain financing for a medical procedure. Such financing should be verified by a physician. In any event the application information may be verified by a data verifier. In practice the application information will include items such as the income, sources of income, assets, debts, and monthly payments of the loan seeker. Furthermore, the database should include the minimum potential borrower income and minimum assets each potential lender requires to grant a loan. In such cases the database can be better searched to identify “best” potential lenders.

A computerized method of loan sourcing according to the principles of the present invention are incorporated in a computerized system that identifies potential lenders interested in issuing credit cards or making loans of the type sought by a borrower. Credit card or loan qualification information is obtained from potential lenders and then that information is stored in a database. The computer system accepts credit card or loan application information from a borrower and obtains that borrower's credit benchmark (score). The credit benchmark (score) and other borrower information is then compiled to form a stratification filter which is used to search the database to identify a “best” potential lender. That lender is then queried to ascertain if they are interested in issuing a credit card or granting a loan to someone similarly situated as the borrower. If the “best” potential lender is interested in issuing a credit card or granting a loan to someone similarly situated as the borrower the computer sends compiled information regarding the borrower and the loan application information to the best potential lender. Beneficially the loan application information includes the desired credit card limit or the amount of the desired loan, which is preferably verified before the best potential lender is queried.

The principles of the present invention can be used to implement a computerized system for financing medical procedures. Potential lenders interested in making unsecured medical procedure financing loans are identified and their loan qualification information is obtained and stored in a database. A potential borrower submits a loan application for a medical procedure. That borrower's credit benchmark (score) is obtained along with medical procedure information, including a cost estimate of the medical procedure. A stratification filter is then formed from the credit benchmark (score), application information, and medical procedure information. The database is searched using the stratification filter to identify a best potential lender. That lender is then queried to ascertain if they are interested in granting a medical procedure loan to someone similarly situated as the borrower. If the best potential lender is interested in granting a medical procedure loan to someone similarly situated as the borrower, the identification of the borrower, the information in the loan application, and the medical procedure information is sent to the best potential lender.

Preferably medical procedure information is obtained from a physician, preferably the one planning on performing the medical procedure. The loan application information should include the cost of the medical procedure. Beneficially the loan application information should be verified before querying the best potential lender.

### BRIEF DESCRIPTION OF THE DRAWINGS

The advantages and features of the present invention will become better understood with reference to the following detailed description and claims when taken in conjunction with the accompanying drawings in which:

FIG. 1 presents the network topology of a computerized credit stratification system 10 that is in accord with the principles of the present invention;

FIG. 2 presents a prototypical database used in the computerized credit stratification system 10 illustrated in FIG. 1;

FIG. 3A is a flow chart depicting part of the operation 200 of the computerized credit stratification system 10; and

FIG. 3B is a flow chart depicting another part of the operation 200 of the computerized credit stratification system 10.

### DETAILED DESCRIPTION OF THE INVENTION

The presently disclosed subject matter now will be described more fully hereinafter with reference to the accompanying drawings in which one embodiment is shown. However, it should be understood that this invention may take many different forms and thus should not be construed as being limited to the specific embodiment set forth herein.

All documents and references referred to in this disclosure are hereby incorporated by reference for all purposes.

In the figures like numbers refer to like elements throughout. Additionally, the terms “a” and “an” herein do not denote a limitation of quantity, but rather denote the presence of at least one of the referenced items.

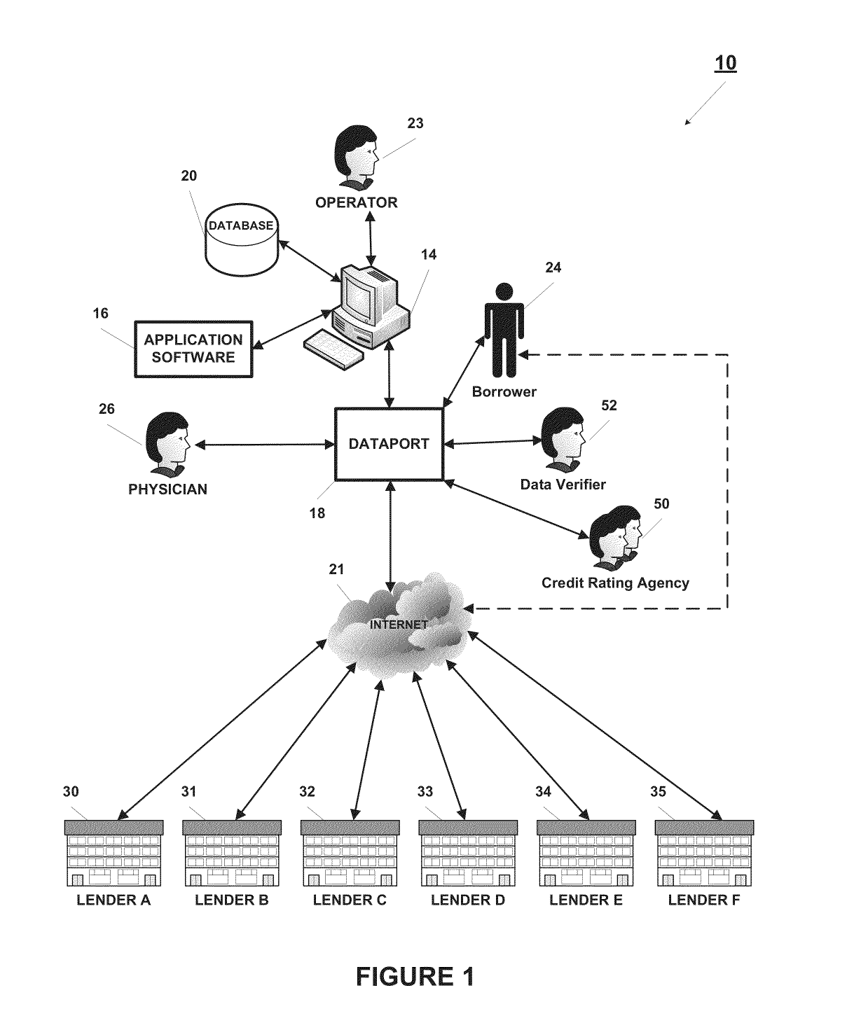

The principles of the present invention are implemented in a computerized credit stratification system 10 depicted in FIGS. 1 through 3B. Those principles implement a credit stratification filtering algorithm that is specifically applied to health care financing. That algorithm assists patient borrowers to obtain medical procedure financing loans in a manner that enables the patent to obtain the best terms possible and with fewer credit pulls.

As shown in FIG. 1, the computerized credit stratification system 10 includes a computer 14 that operates in accord with application software 16. The Application Software 16 causes the computer 14 to implement a dataport 18 and a database 20. The dataport 18 enables the computer 14 to access remote entities (see below) over telephone lines, wireless communication networks, and most beneficially the internet 21. Thus the dataport 18 should be understood as generically representing as many different communication ports as required to enable communications with all entities of interest. The database 20 is explained in more detail subsequently.

The computerized credit stratification system 10 assists financing for a potential borrower 24 seeking financing for a medical procedure to be performed by a physician 26. Such financing may be available from any of a plurality of potential lenders, represented by lender A 30 through lender F 35. It should be understood that the principles of the present invention are explained using the computerized credit stratification system 10 which is directed to medical procedure financing. Other embodiments may not include the physician 26. Other embodiments might implement computerized credit stratification systems for issuing credit cards or for obtaining other types of loans. However, the illustrated embodiment is understood to be sufficiently illuminating that such other embodiments can readily be implemented.

Still referring to FIG. 1, an assumption is made that the borrower 24 wants the physician 26 to perform a medical procedure that requires the borrower 24 to obtain an unsecured loan. Another assumption is that lenders A-F (30-35) are part of the computerized credit stratification system 10; that they make loans for credit worthy borrowers to finance medical procedures; that they have varying loan criteria; and that they have individually set loan rates and terms. For example, lender A 30 may have the best terms but might require a credit score above 90 (ratings being taken from 0, the worst, to 100, the best) to obtain a loan. Lender B 31 might have slightly less favorable terms but might be willing to lend to individuals with credit ratings above 86. Lender C 32 may have the least favorable terms but might be willing to lend to individuals with credit scores above 40. The other lenders D-F (33 through 35), may have varying criteria and rates.

The forgoing describes the use of credit scores of the type compiled by credit reporting agencies and generally relied on by financial institutions when approving loans. However, it should be understood that the principles of the present invention can be used with other types of credit benchmarks. For example, while a credit score is a well known credit benchmark an alternative credit benchmark might simply be net worth. The important criteria is that the credit benchmark be known, understood, and commonly relied on by lenders who are part of the computerized credit stratification system 10 (or another computerized credit stratification system) when approving loans (or credit cards).

The database 20 includes a listing for each of the lenders A-F (30-35), along with the credit scores each lender says it requires to grant a loan. Other data associated with each lender is also in the database 20, for example, the minimum income and assets that each lender wants a borrower to have to obtain a loan, along with the interest rates, terms, and minimum and maximum loans it will consider. Those are examples only. Furthermore, the database 20 is flexible enough to allow the same lender to have multiple entries, such as a credit rating of 85 will correspond to 5% interest while a credit rating of 50 will pay correspond to 12% interest and so on. The more information made available to the computerized credit stratification system 10 the better the loan stratification becomes. Thus the database 20 contains information that allows the computer 14 to search and find lenders who are willing to provide a given loan and under what conditions they are willing to do so.

The borrower 24 uses the dataport 18 and applies for a loan using the computerized credit stratification system 10. The borrower 24 provides loan application information such as their the desired loan, their income, their sources of income, their assets, their debts, their monthly payments, the identification of the physician 26, the medical procedure to be performed, and other pertinent information.

The computerized credit stratification system 10 then pulls the credit report of the borrower 24 from a credit reporting agency 50. The computerized credit stratification system 10 may also query the physician 26 to confirm that the borrower 24 is scheduled to undergo a medical procedure and to verify the cost of that procedure. Furthermore, the computerized credit stratification system 10 may in some applications seek verification of the information provided by the borrower 24 from a data verifier 52.

Assuming that the borrower 24 is scheduled to undergo a procedure and that the cost of that procedure corresponds to the desired loan, and assuming that the data verifier 52 (if used) verifies that the information supplied by the borrower 24 is accurate, the computer 14 searches the database 20 to find one or more lenders who have shown an interest in making loans to borrowers similarly situated as the borrower 24. If one or more suitable lenders, say lenders B and D (31 and 33) are found in the database 20 the lender with the best available terms, say lender B 31, is selected. That lender is queried as to whether they are interested in making the sought after loan to a person similarly situated as the borrower 24.

If the queried lender, say lender B 31 is interested the application information from the borrower 24, along with any information from the physician 26 and the data verifier 52, is sent to lender B 31. If lender B 31 declines to make the loan, either before or after receiving information regarding the borrower 24, the computerized credit stratification system 10 queries another lender, if any, who has indicated an interest in making similar loans to that sought by the borrower 24. For example, to lender D 33. This process might continue for multiple potential lenders.

To avoid undue credit pulls, if no lender has signaled an interest in making the sought after loan to a person similarly situated as borrower 24 the borrower 24 will be informed that no loan is available. Furthermore, only lenders who have indicated an interest in making the sought after loan to a person similarly situated as the borrower 24 will be eligible to receive information about the borrower 24. Finally, the borrower 24 may be able to limit the number of lenders that can receive their information. This will limit the number of credit pulls to that number +1 (for the computerized credit stratification system 10).

The principles of the present invention benefit potential borrowers by allowing the computerized credit stratification system 10 to identify lenders interested in making loans of the type being sought (in the specific embodiment, the financing of medical procedures), by allowing that computerized credit stratification system 10 to find the most favorable terms for the sought after loan, and by limiting the number credit pulls, thus reducing negative impacts on the credit rating of the borrower 24.

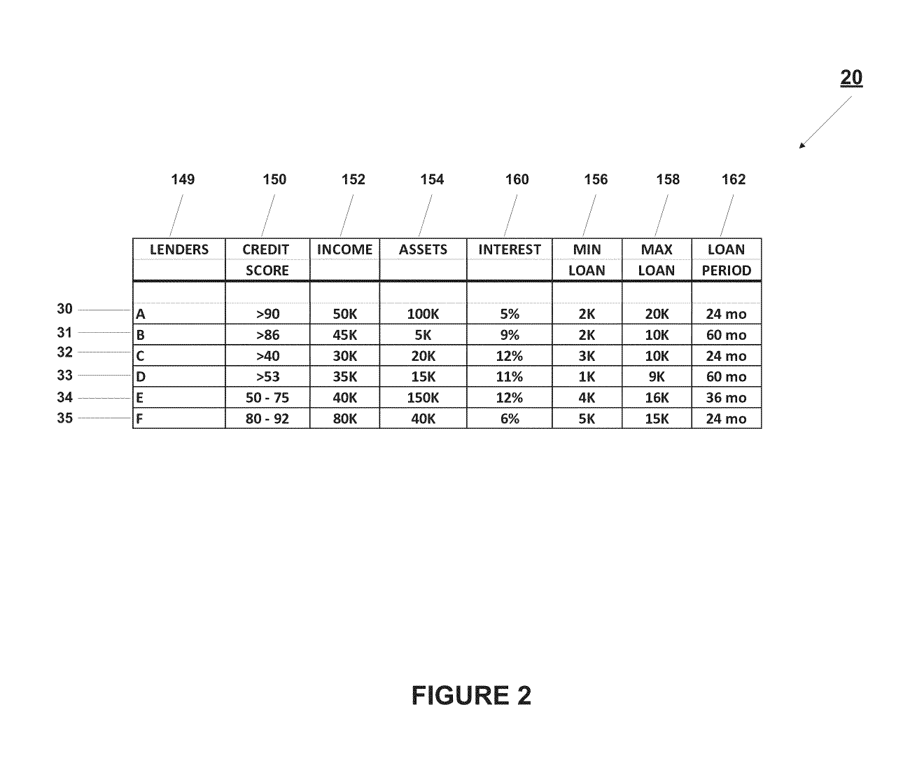

FIG. 2 illustrates a prototypical database 20. As shown the database 20 includes a plurality of lenders 149, specifically the lenders A-F, 30-35, who have shown an interest in participating in the computerized credit stratification system 10. Those lenders 149 have provided the information that they require to make a loan, such as the minimum borrower credit score 150 they are willing to consider under specific interest terms, the required borrower income 152 and assets 154, and the minimum loan 156 and maximum loan 158 they are interested in making. In addition, the lenders 149 will have supplied loan terms, such as the interest 160 they charge and the maximum loan period 162 they will consider. Those are of course merely examples of the type of information that might be contained in the database 20.

Still referring to FIG. 2, it can be seen that it is rather simple for the computer 14 to stratify lenders 149 into a hierarchy of potential lenders. Some will not be interested in making certain loans, some may be interested in making a loan but only under certain conditions, and some may have similar conditions but different terms. In any event the computerized credit stratification system 10 can interrogate the database 20, stratify the lenders 149, and arrive at the “best” lender 149 for a given loan for a given borrower 24.

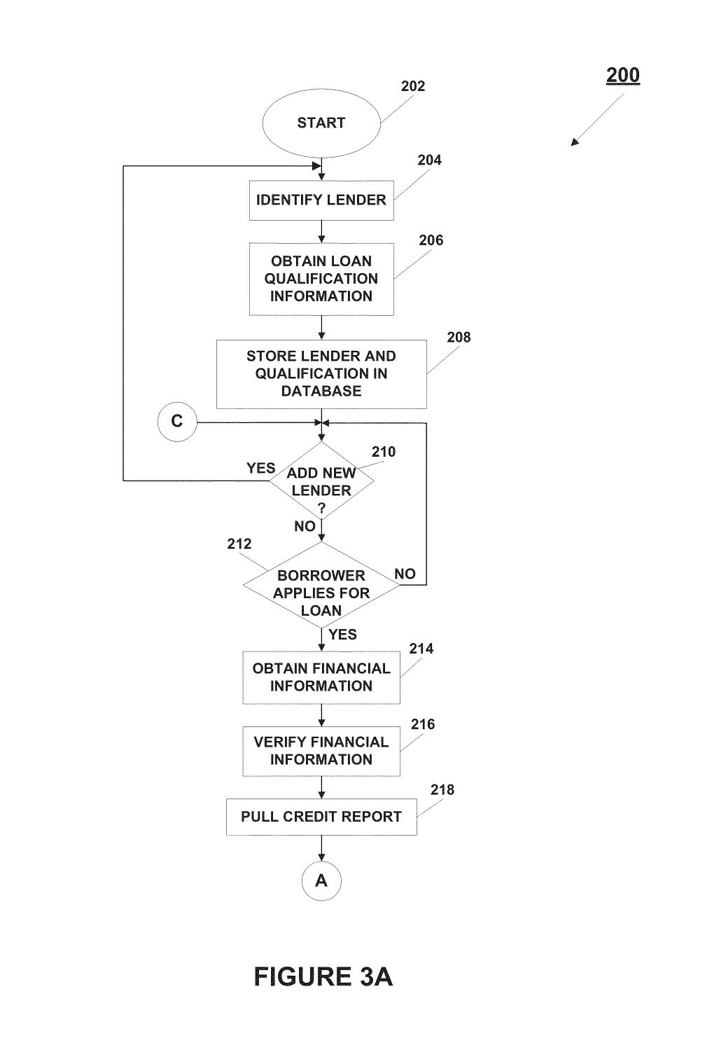

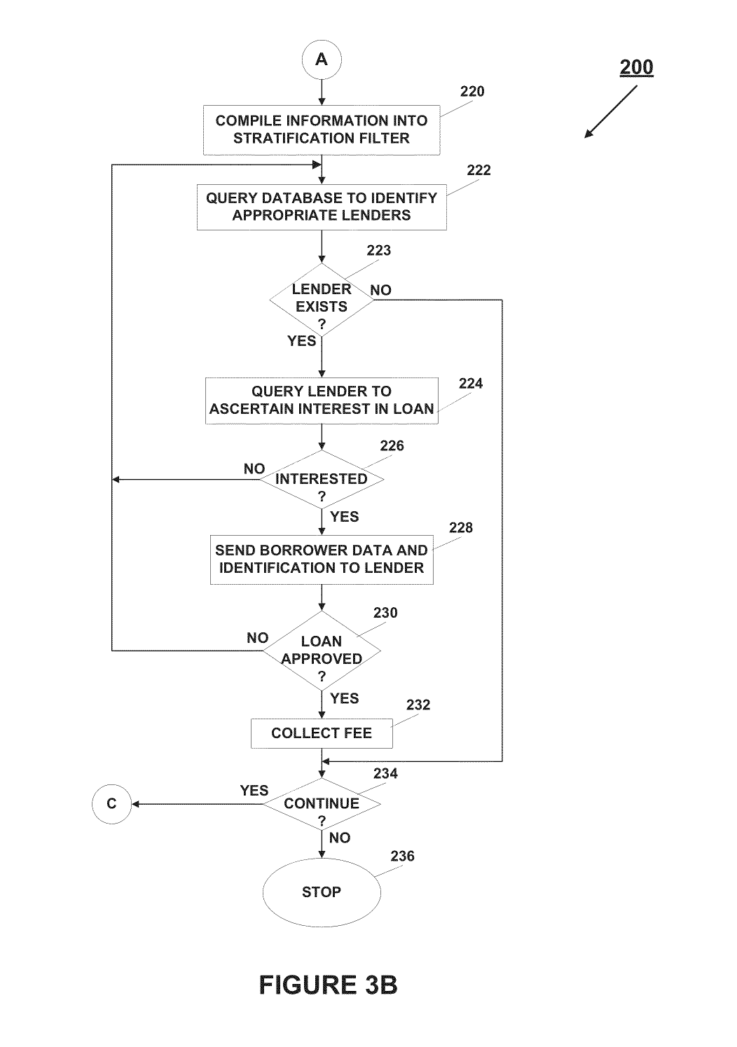

FIG. 3 presents a flow diagram of the operation 200 of the computerized credit stratification system 10. The operation 200 starts, step 202 and proceeds with identifying a lender (address, contact information, email address, web address, etc.) that is interested in participating in the computerized credit stratification system 10, step 204. By participating in the computerized credit stratification system 10 the lender signifies that it is interested in granting loans of the specific type being handled by the computerized credit stratification system 10.

After a lender is identified, step 204, that lender provides loan and loan qualification information to the computerized credit stratification system 10, step 206. For example, a lender might supply the minimum credit rating it will accept for a loan, the minimum borrower income required for a loan, the minimum borrower assets required, the minimum and maximum loans it would be interested in granting, and typical loan terms such as interest rate and repayment period. In practice a lender might enter information numerous times for different loan conditions, such as a 5% interest rate with a credit rating of over 86, a 12% interest rate for a credit rating between 75 and 85, etc. The lender information (address, contact information, email address, web address, etc) together with the information that the lender supplied in step 206 is then caused to be stored by the computer 14 in the database 20, step 208.

After step 208 the database 20 contains information suitable for stratifying loans. However, to better serve potential borrowers the computerized credit stratification system 10 continues to look for additional lenders. To do so, after step 208 a decision is made as to whether a new lender is to be added to the databases 20, step 210. If yes, a loop is made back to step 204 so that the new lender can be identified, their information obtained, and the database 20 is then updated.

However, if in step 210 there is not a new lender the computerized credit stratification system 10 proceeds to step 212 to look for a borrower 24 that applies for a loan. If there is no borrower the operation 200 returns to step 210. A multistep loop is then entered where the computerized credit stratification system 10 looks for either a new lender or for a borrower, steps 210 and 212.

When a borrower 24 applies for a loan the computerized credit stratification system 10 obtains financial information from the borrower 24, step 214. That information beneficially includes identification information for the borrower 24, such as their mail address, email address, web address, and financial information such as income, amount of loan sought, the purpose of the loan, assets, credit and payment history, current and former employer, past loans, the physician 26, and possibly credit references. The obtained information may include the maximum number of credit pulls the borrower 24 wants performed. This can be used to protect the credit rating of the borrower 24.

After step 214 the computerized credit stratification system 10 seeks to verify the information provided by the borrower 24, step 216. This step is optional, but useful to both the borrower 24 and to potential lenders. To that end, the operator of the computerized credit stratification system 10 can send information to the data verifier 52.

Either before or after receiving a report from the data verifier 52 (if any) the computerized credit stratification system 10 pulls the credit report of the borrower 24, step 218.

With the credit report available, with the information supplied by the borrower 24 available, and with information from the data verifier 52 (if any) available, the computerized credit stratification system 10 compiles all of that information to form a stratification filter, step 220. The computerized credit stratification system 10 uses the stratification filter as a template to query the database 20 to identify appropriate lenders, step 222.

When performing step 222, lenders A-F (30-35) that have indicated that they are not interested in granting loans to borrowers similarly situated to borrower 24 are placed at the bottom of a lending queue. However, the lenders A-F (30-35) that have indicated that they are interested in granting loans to borrowers similarly situated to borrower 24 are placed toward the top of the lending queue. Then, the lenders with favorable terms, such as loan duration and interest rates are sorted to be located higher in the lending queue.

It is possible that there is no lender that is interested in making a loan. Therefore, if after step 222 there is no lender interested in making a loan to a borrower similarly situated to the borrower 24 the operation 200 of the computerized credit stratification system 10 passes to step 234 which is described in more detail subsequently, step 223. However, if the computerized credit stratification system 10 does identify a lender interested in making a loan to a borrower similarly situated to borrower 24 the operation 200 of the computerized credit stratification system 10 passes to step 224.

In step 224, the computerized credit stratification system 10 queries the “best” of the stratified lenders to determine if they are actually interested in making a loan to a borrower similarly situated as the borrower 24. The “best” lender then makes a decision as to whether they are interested in considering making the sought for loan, step 226. If the “best” lender is not interested another suitable lender is selected by returning to step 222, step 226.

However, if in step 226 a lender signifies interest in granting a loan to a borrower similarly situated to the borrower 24, that lender is supplied with specific information about the borrower 24, step 228. Specifically, that lender is supplied with the borrower's 24 name, contact information, assets, income, the information on the application, the name and contact information of the physician 26, and information from the data verifier 52 (if any).

Step 228 is the first time that any lender is provided with specific information about the borrower 24. At all other times the computerized credit stratification system 10 has been “pre-qualifying” the borrower 24 while minimizing any harming to his credit by limiting credit pulls. The borrower 24 also benefits by having his loan information targeted to an appropriate lender, while the lender is supplied with a “pre-qualified” loan application of the type in which the lender is interested in making.

The lender then decides whether to approve the loan, step 230. If the loan is not approved the operation 200 returns to step 222 for selection of another potential lender. However, if the loan is approved the Operator 23 of the computerized credit stratification system 10 collects a fee, step 232. A decision is then made as to whether to continue operating, step 234. That same decision is made if in step 223 there is no lender interested in making a loan to a borrower similarly situated to borrower 24. If yes (as it will almost always be) the operation 200 returns to step 210. Otherwise the operation 200 stops, step 236.

In an alternate embodiment, the invention encompasses a computerized method of obtain credit cards comprising the steps of: identifying potential credit card issuers interested in issuing credit cards; obtaining credit card qualification information from the potential credit card issuers; storing the identified potential credit card issuers and their credit card qualification information in a database; accepting a credit card application information from a consumer; obtaining a credit benchmark of the consumer; compiling consumer information; forming a stratification filter from the compiled information; searching a database using the stratification filter to identify a best potential credit card issuer; querying the best potential credit card issuer to ascertain if they are interested in issuing a credit card to someone similarly situated as the consumer; and sending the compiled information and consumer identification to the best potential credit card issuers if the best potential credit card issuers is interested in granting a credit card to someone similarly situated as the consumer.

In a further alternative embodiment, the invention encompasses a computerized credit stratification system for assisting a credit card seeker obtain a credit card, said system comprising a computer executing application software that causes said computer to implement a database and a communication dataport in functional communication with said computer; wherein said database includes at least one credit benchmark measurement required to obtain a credit card from each potential credit card issuer of a plurality of potential credit card issuers; wherein said application software enables said computer to obtain application information over said dataport from the credit card seeker; wherein said application software causes said computer to obtain the credit benchmark for the credit card-seeker; wherein said application software causes said computer to search the database to identify potential credit card issuers that will consider issuing a credit card to a consumer having said credit card seeker's credit benchmark; stratifying said identified potential credit card issuers according to credit benchmark measurements into a hierarchy of potential credit card issuers to identify a best potential credit card issuer for the credit card seeker; and wherein said best potential credit card issuer is queried as to whether they are interested in issues a credit card to a potential consumer having said credit card seeker's credit benchmark.

It is to be understood that while the figures and the above descriptions illustrate the present invention, they are exemplary only. They are not intended to be exhaustive or to limit the invention to the precise forms disclosed, and obviously many modifications and variations are possible in light of the above teaching. In particular, the principles of the present invention can be used to implement computerized credit stratification system for obtaining other types of loans or for obtaining credit cards. In addition it should be understood that the use of credit scores is simply one type of credit benchmarks that might be used to stratify lenders. Others who are skilled in the applicable arts will recognize numerous modifications and adaptations of the illustrated embodiments that remain within the principles of the present invention. Therefore, the present invention is to be limited only by the appended claims.

1. A computerized credit stratification system for assisting a loan seeker obtain a desired loan, said system comprising a computer executing application software that causes said computer to implement a database and a communication dataport in functional communication with said computer;
wherein said database includes at least one loan term and a credit benchmark required for a loan for each potential lender of a plurality of potential lenders;
wherein said application software enables said computer to obtain application information over said dataport from the loan-seeker;
wherein said application software causes said computer to obtain a credit benchmark for the loan-seeker;
wherein said application software causes said computer to search the database to identify potential lenders that will consider granting a loan to a potential borrower having said loan-seeker's credit benchmark;
stratifying said identified potential lenders according to said at least one loan term into a hierarchy of potential lenders to identify a best potential lender for the loan seeker; and
wherein said best potential lender is queried as to whether they are interested in making the desired loan to a potential borrower having said loan-seeker's credit benchmark.

2. A computerized credit stratification system according to claim 1, wherein said desired loan is for a medical procedure.

3. A computerized credit stratification system according to claim 2, wherein said computer receives verification from a physician that said loan seeker is to undergo a medical procedure, and wherein the cost of said medical procedure is verified by said physician.

4. A computerized credit stratification system according to claim 2, wherein if said best potential lender declines to make the desired loan the computer selects another potential lender lower in the hierarchy that is then queried as to whether they are interested in making the desired loan to a potential borrower having said loan-seeker's credit benchmark.

5. A computerized credit stratification system according to claim 1, wherein said application information includes income, sources of income, assets, debts, and monthly payments.

6. A computerized credit stratification system according to claim 5, wherein said database includes minimum potential borrower income and minimum assets each potential lender requires to grant a loan.

7. A computerized credit stratification system according to claim 1, wherein said database enables said computer to search for potential lenders willing to grant the desired loan and under what conditions they are willing to do so.

8. A computerized method of financing comprising the steps of:
identifying potential lenders interested in making loans;
obtaining loan qualification information from the potential lenders;
storing the identified potential lenders and their loan qualifications in a database;
accepting loan application information from a borrower;
obtaining a credit benchmark of the borrower;
compiling borrower information;
forming a stratification filter from the compiled information;
searching a database using the stratification filter to identify a best potential lender;
querying the best potential lender to ascertain if they are interested in granting a loan to someone similarly situated as the borrower; and
sending the compiled information and borrower identification to the best potential lender if the best potential lender is interested in granting a loan to someone similarly situated as the borrower.

9. A computerized method of financing according to claim 8, wherein the loan application information includes the amount of the desired loan.

10. A computerized method of financing according to claim 9, further including a step of verifying the loan application information before querying the best potential lender.

11. A computerized method of financing according to claim 9, wherein the desired loan is for financing a medical procedure.

12. The computerized method of financing according to claim 9 wherein the best lender pays a fee for finding the borrower if the desired loan is granted.

13. A computerized method of financing a medical procedure comprising the steps of:
identifying potential lenders interested in making unsecured medical procedure financing loans,
obtaining loan qualification information from the potential lenders;
storing the identified potential lenders and their loan qualification information in a database;
accepting a loan application from a borrower for a medical procedure;
obtaining a credit benchmark of the borrower;
obtaining medical procedure information including a cost estimate of the medical procedure;
compiling information in the loan application, credit benchmark, and medical procedure information;
forming a stratification filter from the compiled information;
searching a database using the stratification filter to identify a best potential lender;
query the best potential lender to ascertain if they are interested in granting a medical procedure loan to someone similarly situated as the borrower; and
sending the compiled information and borrower identification to the best potential lender if that best potential lender is interested in granting a medical procedure loan to someone similarly situated as the borrower.

14. A computerized method of financing according to claim 13, wherein the step of obtaining medical procedure information is performed by contacting a physician.

15. A computerized method of financing according to claim 13, wherein the step of obtaining medical procedure information is performed by contacting the physician planning to do the medical procedure.

16. A computerized method of financing according to claim 13, wherein the loan application information includes the amount of the medical procedure loan.

17. A computerized method of financing according to claim 13, further including a step of verifying the loan application information before querying the best potential lender.

18. The computerized method of financing according to claim 13 wherein the best lender pays a fee for finding the borrower if the medical procedure loan is granted.
